(19) United States
(12) Patent Application Publication
(10) Pub. No.: US 2021/0110496 A1
(43) Pub. Date: Apr. 15, 2021

(54) System, Method, and Computer Program Product for Educational Management System

(71) Applicant: ERIC KMIEC, RANCHO CORDOVA, CA (US)

(72) Inventor: ERIC KMIEC, RANCHO CORDOVA, CA (US)

(21) Appl. No.: 16/600,694

(22) Filed: Oct. 14, 2019

(51) Int. Cl. G06Q 50/20; G06Q 50/00; G06Q 30/00; G06Q 30/02; G06F 16/23

(52) U.S. Cl. CPC G06Q 50/2053; G06Q 50/01; G06F 16/2315; G06Q 30/0201; G06Q 30/018

(57) ABSTRACT

The present invention provides a computer-implemented educational management system that empowers educators to create new student-centric guided pathways that help increase college readiness, accelerate college completion and improve student outcomes and career readiness for all, throughout our education system. By providing all the key college touchpoints throughout the students' journey and guiding them every step of their college experience, the present invention enables colleges to keep students on track and prepares them for successful entry into the workforce. The present invention further facilitates labor market readiness through employer-education linkages and by seamlessly connecting students to workforce opportunities. The present invention further provides comprehensive practitioner dashboards that enables the secure and consistent alignment, collection and real-time reporting of key performance accountability metrics for various state and federal programs.

### CROSS-REFERENCE TO RELATED APPLICATIONS

This application is a non-provisional of and claims priority to and the benefit of U.S. provisional patent application Ser. No. 62/746,551, entitled “System, Method, and Computer Program Product for Educational Management System” and filed on Oct. 17, 2018, which is incorporated by reference herein in its entirety.

### BACKGROUND

### Technical Field of the Invention

The present invention relates generally to the field of educational management system. More particularly, the present invention relates to a method, system and computer program product for monitoring and managing the education progress of a student by an educational institution.

### Background of the Invention

Postsecondary education is a key driver to every nation's economic growth and competitiveness in the global marketplace. The community colleges serve nearly half of the undergraduate students in the US and therefore they are a key component of the postsecondary education system. In recent years, student success rate at the community colleges across the US has become a major area of concern for all stakeholders—for academia who provides the education, for the government who supports these colleges to generate future workforce critical for the continued economic growth, and for the parents of students who invest their money and time expecting their kids to succeed and become financially independent. And of course, for the students themselves who often find lost in a maze of offered courses and plethora of paths taking them to nowhere. The statistics speak for themselves. Only four out of ten community college students complete any degree or certificate within six years of enrollment. Therefore, there is a big public push to reform and strengthen the post secondary education system, especially the community college system.

The reasons for the low student outcomes in the postsecondary are multifold. Generally, most students who enroll in a community college system are not sure about their education and career goals when they begin the program. The limited counselling they receive at the beginning somewhat help them pick a few courses. However, the current college education system with a cafeteria model often confuses the majority of students and generally doesn't provide a clear path to graduation. The students, typically, end up taking courses that are not relevant to their career goals or that do not contribute to their graduation. Moreover, even if students are taking the right courses, the colleges lack an efficient technology enabled methods to monitor the progress of each student. In the absence of clear, real-time visibility of student progress, the students often are at risk to lose motivation and give up the studies.

A journey of a college student begins even before they are enrolled in a college. Therefore a student outreach program of any education institution is a first and a very crucial step towards attracting and then well informing students about the institution's available study programs, and future opportunities for transfer or career. This step generally offers advising services including available student aid options and eligibility criteria, and the student outreach process therefore holds tremendous value for students especially for first-generation, low-income and minority students. At present, such information is generally disseminated to students via offline events, paper brochures, and even via telephone, and to some extent via email campaigns. However, using this offline multi-channel process the colleges are not able to thoroughly measure the reach and effectiveness of such obsolete methods of student outreach. Moreover, these programs are created with an approach of one size fits all. The colleges currently lack technology-enabled comprehensive services that can maximize their return on investment both in time and money to attract students, and services that are also beneficial for prospective students.

With popularity of technology in general and internet in particular among students of the twenty first century, there has been a consistent movement among the educators and college administrators to capitalize on the power of technology to make overall management of the education more efficient and increasingly effective. The colleges have started to adopt various technology enabled platforms and tools that use internet to manage and communicate with their students. Many educational management systems have been introduced in the education space in the last two decades. These systems offer a variety of functionalities for educators to manage the overall process and also to disseminate information to students. Typically, such processes and information pertain to but not limited to, student enrollment, course study material, class schedules, grades, attendance, tutoring, etc. However, the existing educational management systems lack a comprehensive system to track the student progress as the student goes through the program pathways to complete their graduation. There is a very limited visibility of student progress to the educators and other stakeholders throughout the lifecycle of a college student. That results in very limited opportunities for educators to intervene, help, motivate or reward students as they progress through program milestones. Furthermore, the existing educational management systems offer a very limited two-way interactive opportunities and methods between educators and students. These systems therefore lack a tool in the hands of educators that can enable them perpetually track and interact with students and thereby help them at every stage of student journey.

Furthermore, the governments both at the state and federal level are anxious to address the greater challenge of low student outcomes at the community college level. There are various ongoing programs that are funded by the state and federal agencies to help colleges grapple with this problem. When the agencies invest taxpayer dollars into the community college system, they expect an effective utilization of the funds and a clear measure of the outcomes. At present, the various government institutions generally rely on disparate systems to get very limited information on the results achieved from various funding initiatives. Most of the information needed by such institutions is generated either manually by generating various reports or such information is derived from the data received across multiple systems via email and other proprietary methods. These systems generally are part of the legacy systems that do not leverage the power of real-time analytics, artificial intelligence, blockchain and other emerging technologies and tools based on such technologies.

Human resource professionals are reporting a growing gap in soft skills needed regardless of industry or job type. The country's long-term economic prosperity is being threatened by a skills gap that just keeps growing, according to the Society for Human Resource Management's 2019 State of the Workplace report. Business and HR leaders view the skills shortage as a top concern that needs to be addressed. Among HR professionals, 75% of those having recruiting difficulty say there is a shortage of skills in candidates for job openings. To address the skills shortage, the United States needs a world-class, highly skilled workforce. This will require training workers, collaborating with educational institutions to improve graduate employability, and competing globally for top talent. Foreign-born talent is a necessary complement to the U.S. workforce as businesses become increasingly interconnected globally. The Public Policy Institute of California estimates by 2025 California will face a shortage of 1 million college degree and certificate holders needed to fuel its workforce.

It is essential that we improve student outcomes to address projected shortfalls in postsecondary credentials and to meet employer needs for a skilled workforce [Particularly because “only about half of degree-seeking students achieve their educational goal—for Latinos and African-Americans the rate is even lower,” California Community College's Student Success Task Force (2012)]. Practitioners in higher education need a system that addresses barriers to goal completion.

Finally, the relationship between community colleges and their feeder institutions is considered to be very weak at present. The communication between the two systems happen mostly by exchange of e-documents via emails, paper documents or through face to face meetings among the administrators of these institutions. There is a clear disconnect between the high schools and the colleges as no common data system exists that bridges the two islands and thereby equips students as they transition from K12 to college system. For example, the students often do not have a digital way to track or carry along their credits of what they have earned while studying at the high school as part of the dual enrollment program.

Accordingly, a need exists for an improved method, system and a computer program product for educational institutes in general and community colleges in particular to achieve efficiencies with their educational management processes, and more importantly, to achieve significantly higher student success rates.

### BRIEF SUMMARY OF THE INVENTION

The present invention provides a system, method and computer program that overcomes many of the prior art problems. The present invention provides an effective, systematic and unified way to enable colleges, governments and students accomplish their shared goal: to enable students successfully complete the college program and then either transfer to a four year degree program or join the workforce based on their completed course.

A cloud hosted educational management system of the present invention consists, in the preferred embodiment, of seven primary components: (a) a login portal for user authentication and access to the portal; (b) an Outreach portal for student outreach and engagement; (c) a Pathways portal for publishing and managing guided career pathways; (d) an Administration portal for system management, permissions and for college partnership integration engaged in various stakeholder initiatives; (e) A Super-administrator portal for managing access to the system; (f) a Bridgeway portal for seamless integration of college with their feeder K-12 schools (g) a Workforce portal for business/enterprise partnership engagement, and for connecting students to workforce opportunities, and; (h) a Database for storing data used by the seven preceding portals and the login system.

The preferred embodiment of the present invention also consists of three other components. These three components are a) Analytics based portal b) Machine Learning and Artificial Intelligence based portal and c) Blockchain based portal.

One object of the present invention is to provide a unified platform over computer network that enables colleges to guide students on a pathway that leads to student success.

Another object of the present invention is to enable colleges to offer a transformative student experience through the use of a guided pathways approach which encourages intentional learning paths when designing academic and career goals.

Another object of the present invention is to put students firmly at the center and builds personalized guided pathways designed to keep students focused, and on track to complete their educational and career goals.

Another object of the present invention is to expand career pathway affirmation by propelling participants through a series of facilitator inspired co-curricular engagement activities that spur the process of career actualization when considering inherent occupational/professional skills, contrasted with the knowledge, skills, and abilities of an industry interest area.

Another object of the present invention is to help students backward map occupational plans by focusing on labor market information critical to regional workforce opportunities and encourage the completion of work-based learning to substantiate career interests.

Another object of the present invention is to empower college officials by offering a pathway authoring tool to design career pathway maps linked to educational certificate and degree programs from K-12 to postsecondary and beyond.

Another object of the present invention is to help college officials utilize relevant career development nomenclature and components of the work-based learning continuum developed by Linked Learning, learners matriculate through a career education path by passing through “Student Success and Career Readiness Milestone Markers” that incentivize actions worthy of achievement and emulation.

Another object of the present invention is to serve as a completion tool kit and practitioner dashboard that provides key stakeholders the necessary information to help students acquire professional skills while completing academic and career readiness milestones.

Another object of the present invention is to empower students with a skills building survey module, called PersonaGraf, designed to create a unique awareness that describes students' employability skills essential for successful workforce performance.

Another object of the present invention is to empower students with a guided education tool called Stargate Navigator, designed to map out out a student's entire education journey; from career exploration through matriculation to graduation and into the workforce, tracking engagement and milestone completion at every step of the way.

Another object of the present invention is to enable the education system to offer the use of a workforce portal, designed to develop robust connections between community colleges, business and industry representatives, labor and other regional workforce development partners to align college programs with regional and industry needs, and to facilitate connecting students with local and regional workforce opportunities through an online workforce exchange service.

Another object of the present invention is to provide comprehensive practitioner dashboards that enables the secure and consistent alignment, collection and reporting of key performance accountability metrics for various state and federal programs such as Workforce Innovation and Opportunity Act (WIOA) and Strong Workforce.

Additional objects and advantages of the present invention will become apparent to those skilled in the art upon consideration of the following detailed description, taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE DRAWINGS

FIG. 1 illustrates a block diagram of the educational management system showing all the different components of the system according to an embodiment of the present invention;

FIG. 2 illustrates an architectural diagram of the educational management system according to an embodiment of the present invention;

FIG. 3 illustrates another block diagram of the educational management system showing various components of the system along with different stakeholders accessing the system according to an embodiment of the present invention;

FIG. 4 illustrates a block diagram of the Outreach component of the system according to an embodiment of the present invention;

FIG. 5 illustrates a block diagram of the Pathways component of the system according to an embodiment of the present invention;

FIG. 6 illustrates a block diagram of the Stargate Navigator sub-component of the Pathways component of the system according to an embodiment of the present invention;

FIG. 7 illustrates a process diagram of the Milestone Marker sub-component of the Pathways component according to an embodiment of the present invention;

FIG. 8 illustrates a block diagram of the Personagraf sub-component of the Pathways component according to an embodiment of the present invention;

FIG. 9 illustrates a process diagram of the Personagraf sub-component of the Pathways component according to an embodiment of the present invention;

FIG. 10 illustrates another process diagram of the Personagraf sub-component of the Pathways component according to an embodiment of the present invention;

FIG. 11 illustrates another process diagram of the Personagraf sub-component of the Pathways component of the system according to an embodiment of the present invention;

FIG. 12 illustrates a block diagram of the Bridgeway component of the system according to an embodiment of the present invention;

FIG. 13 illustrates a block diagram of the Workforce Exchange sub-component of the Workforce component according to an embodiment of the present invention;

FIG. 14 illustrates a block diagram of the Partner sub-component of the Workforce component according to an embodiment of the present invention;

FIG. 15 illustrates a block diagram of the Strong Workforce sub-component of the Workforce component according to an embodiment of the present invention;

FIG. 16 illustrates a block diagram of the Administration component of the system according to an embodiment of the present invention;

FIG. 17 illustrates a block diagram of the Administration component of the system according to an embodiment of the present invention;

FIG. 18 illustrates a process diagram of the Outreach component according to an embodiment of the present invention;

FIG. 19 illustrates a process diagram of the Pathways component according to an embodiment of the present invention;

FIG. 20 illustrates a process diagram of the Administration component according to an embodiment of the present invention;

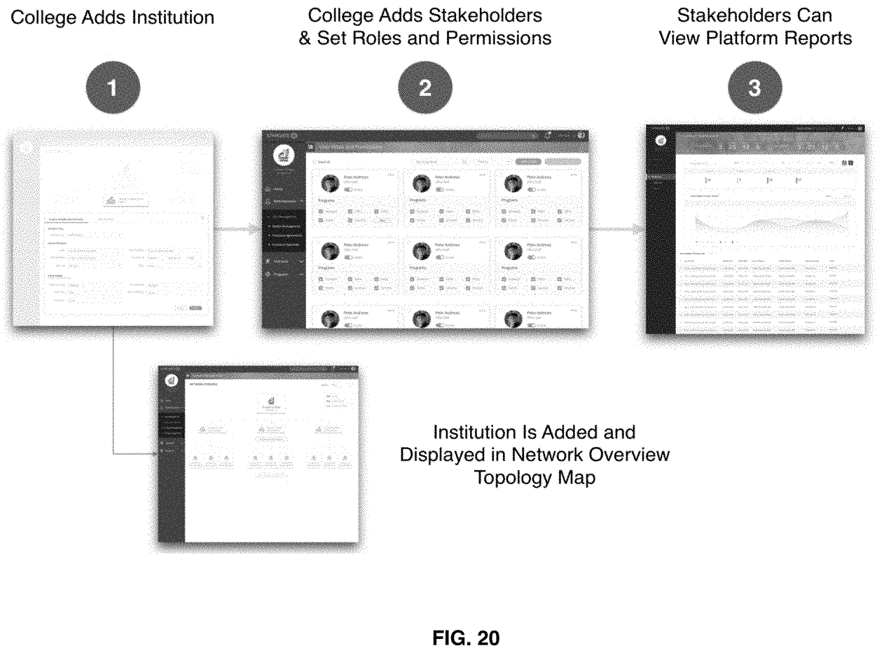

FIG. 21 illustrates a process diagram of the Bridgeway component according to an embodiment of the present invention;

FIG. 22 illustrates a process diagram of the blockchain sub-component of the Bridgeway component according to an embodiment of the present invention;

FIG. 23 is a screenshot of an Outreach component generated by a graphical user interface (GUI) of the computer program product according to an embodiment of the present invention.

FIG. 24 is a screenshot of a system management subcomponent of the Administration component generated by a graphical user interface (GUI) of the computer program product according to an embodiment of the present invention.

FIG. 25 is a screenshot of a Workforce component generated by a graphical user interface (GUI) of the computer program product according to an embodiment of the present invention.

FIG. 26 is a screenshot of a career marketplace sub-component of the Workforce component generated by a graphical user interface (GUI) of the computer program product according to an embodiment of the present invention.

FIG. 27 is a screenshot of a strong workforce sub-component of the Workforce component generated by a graphical user interface (GUI) of the computer program product according to an embodiment of the present invention.

FIG. 28 is a screenshot of an authoring tool of the Pathway component generated by a graphical user interface (GUI) of the computer program product according to an embodiment of the present invention.

FIG. 29 is a screenshot of a partner sub-component of the Workforce component generated by a graphical user interface (GUI) of the computer program product according to an embodiment of the present invention.

FIG. 30 is a screenshot of a Reporting component generated by a graphical user interface (GUI) of the computer program product according to an embodiment of the present invention.

FIG. 31 is a screenshot of an Personagraf sub-component of the Pathway component generated by a graphical user interface (GUI) of the computer program product according to an embodiment of the present invention.

FIG. 32 is another screenshot of an Personagraf sub-component of the Pathway component generated by a graphical user interface (GUI) of the computer program product according to an embodiment of the present invention.

### DETAILED DESCRIPTION OF THE PREFERRED EMBODIMENTS

While the invention is susceptible to various modifications and alternative forms, the present invention now will be described more fully hereinafter with reference to the accompanying drawings, in which a preferred embodiment of the invention is shown.

The educational management system according to the preferred embodiment of the present invention provides a new and comprehensive system, method and computer program product for improved community college student outcomes.

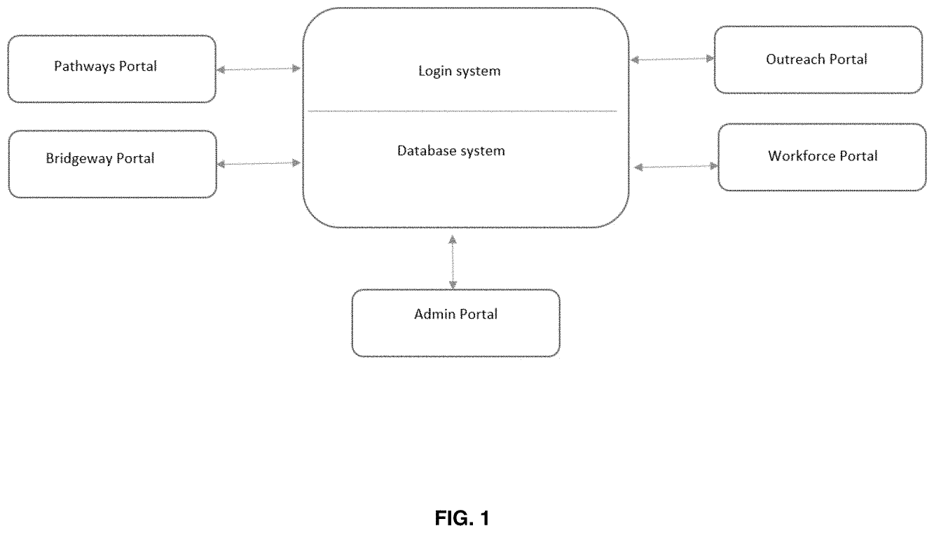

Referring to FIG. 1, the educational management system of the present invention consists of seven primary components in the preferred embodiment: i) a login portal for authenticating users and permitting access to the portals; ii) an outreach portal for allowing college to create various outreach programs and engage with students; iii) a pathways portal for publishing and managing guided career pathways; iv) an administrative portal for managing customer access to the system and for sharing student progress data with governments and other stakeholders; v) a bridgeway portal that connects the feeder high school students with the community college for capturing data and managing articulation and dual-enrollment credit information relating to courses, classes, high school ROP districts, high schools, teachers, counselors, college registrars, college advisors, and students; vi) a workforce portal for business/enterprise partnership engagement, and for connecting students to workforce opportunities, and; vii) a database or multiple database systems for storing data used by the preceding portals and the login portal. FIG. 1 shows a general relationship of these seven primary components of the system. A more detailed description of each component of the system is presented below.

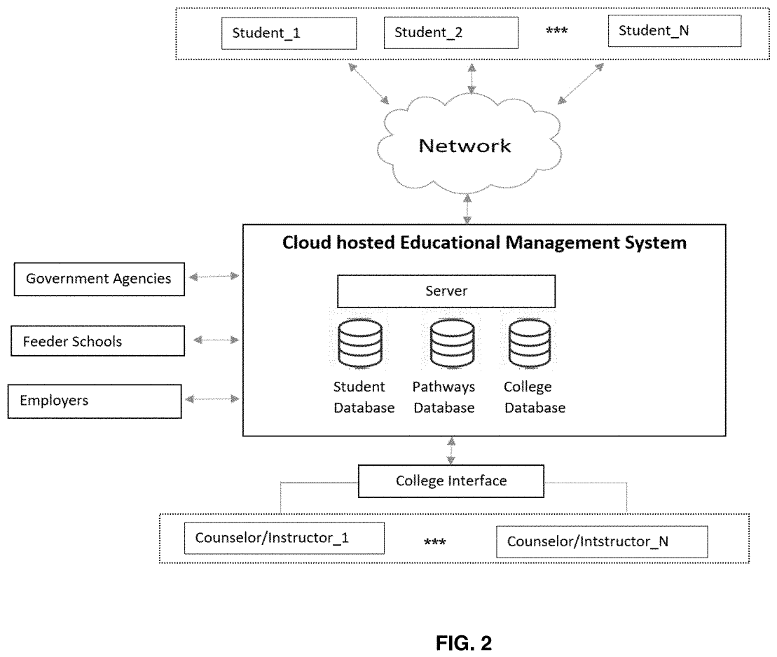

Referring to FIG. 2, the educational management system of the present invention connects and offers services to broadly five different stakeholders—i) the college, ii) the student, iii) the government and other related institutions, iv) the feeder high school, v) the employer. The educational management system is offered to each college on cloud, as software as a service (SaaS) model. As depicted in the FIG. 2 all the stakeholders connected with that college shall also avail the service of the system on the cloud after securing appropriate authorization from the college.

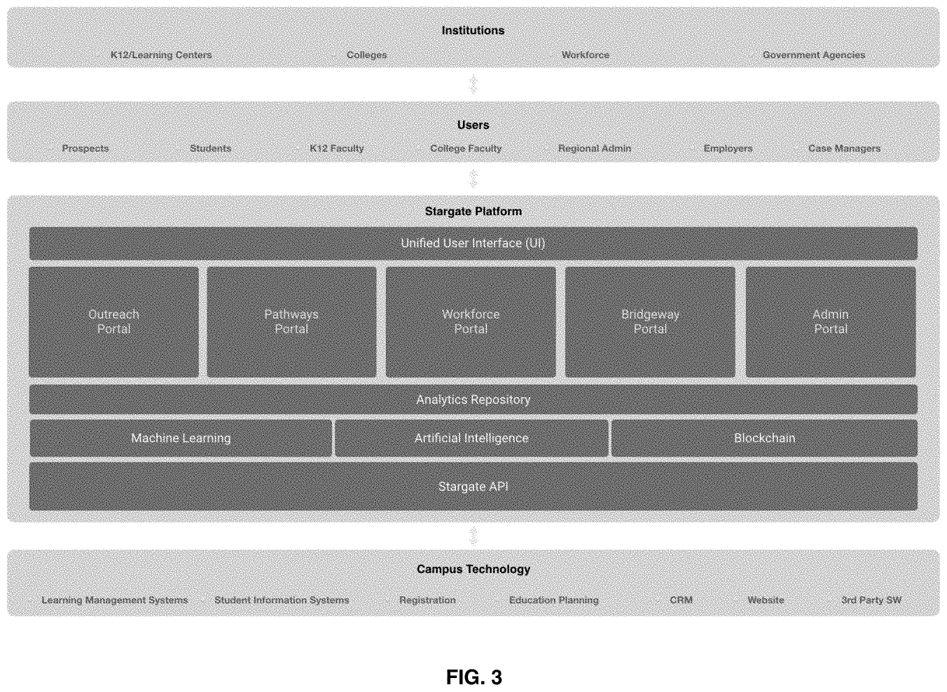

The FIG. 3 outlines various external systems that the educational management system as a preferred embodiment of the invention can connect with. A few examples of such external systems include, but not limited to, a learning management system, a student information system, a legacy system, etc.

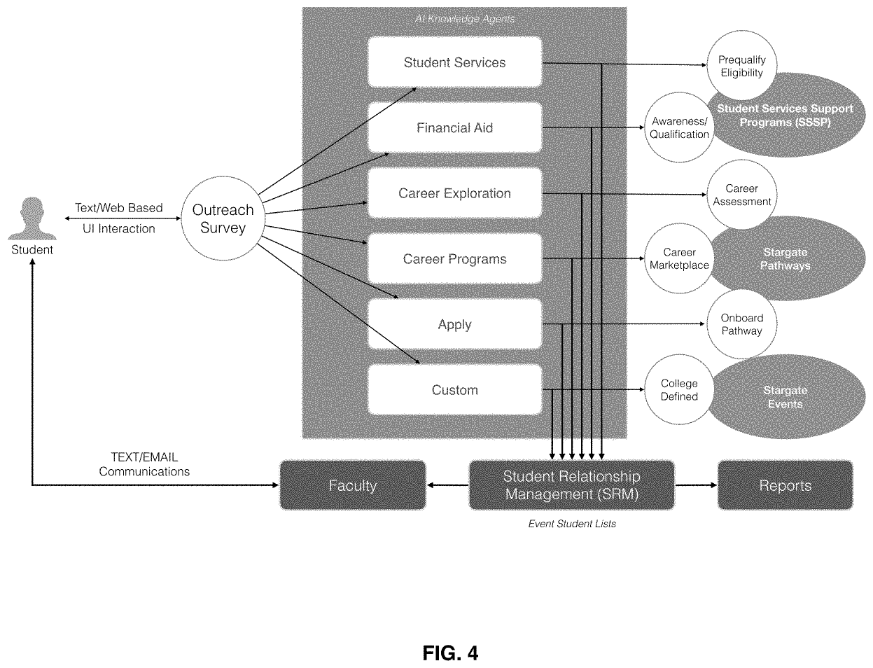

Referring to FIG. 4, the Outreach portal provides colleges opportunities to communicate, engage and build relationships with their students. This service improves student services support program (SSSP) effectiveness, communications and identify eligible students more effectively. The portal also strengthens support for entering students and tracks their interactions with the college; creates and manages college outreach and recruitment campaigns/events. The Outreach portal also helps connect underserved students with the community college and thereby with the available resources for such underserved students.

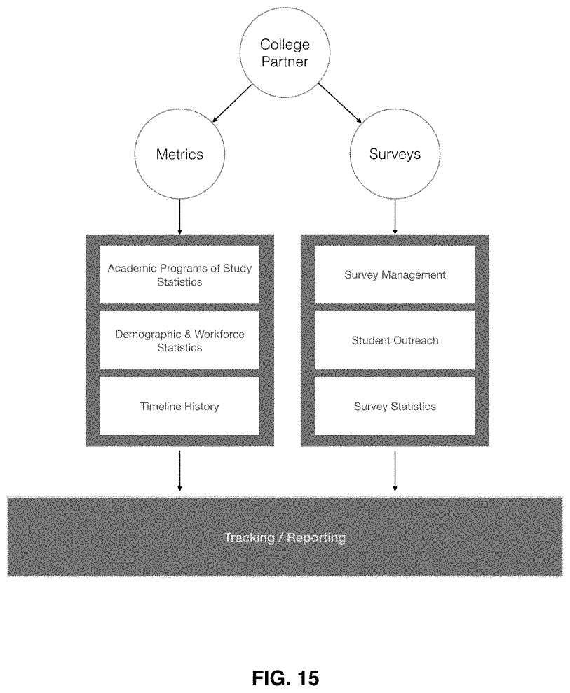

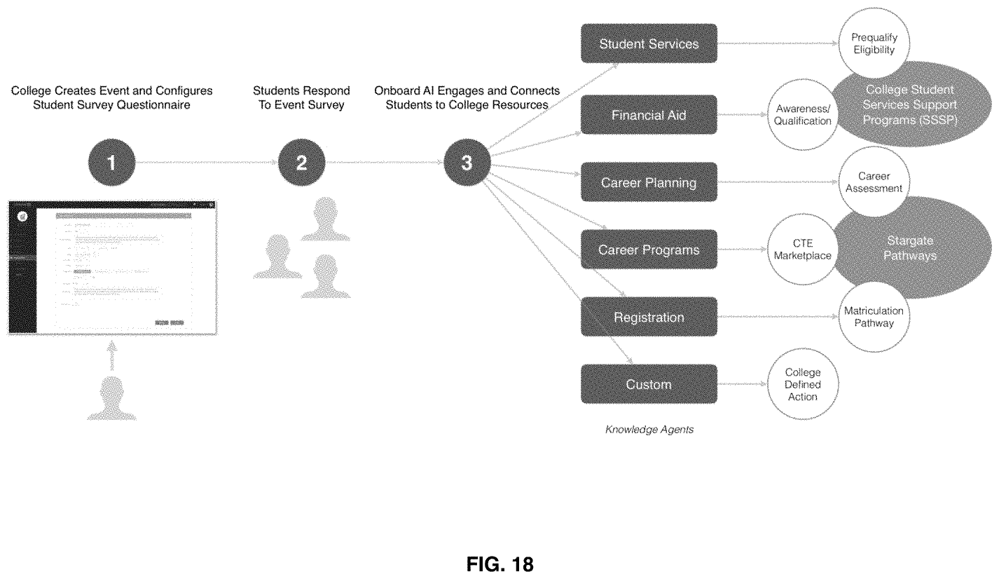

FIG. 18 illustrates the manner in which a user from a college interacts with students using the Outreach portal of a preferred embodiment of the present invention. In the step 1, the user creates an event and configures a student survey questionnaire. The system sends the event and the survey to the students who are in the system. In step 2, a student replies to the survey and completes the questionnaire. In step 3 the onboard AI system engages and connects students with appropriate resources. The FIG. 15 also illustrates how different agents of the system service these students. These agents of the Outreach system are, but not limited to, Student Services, Financial Aid, Career Planning, Career Programs, and Registration. The Outreach portal also allows a college to create any custom service for the students.

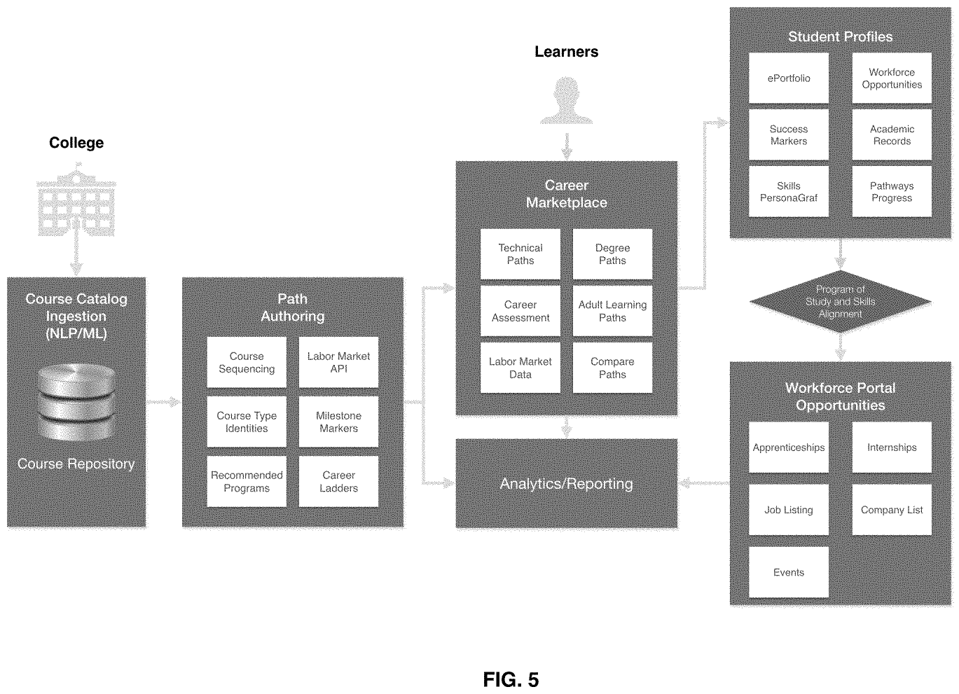

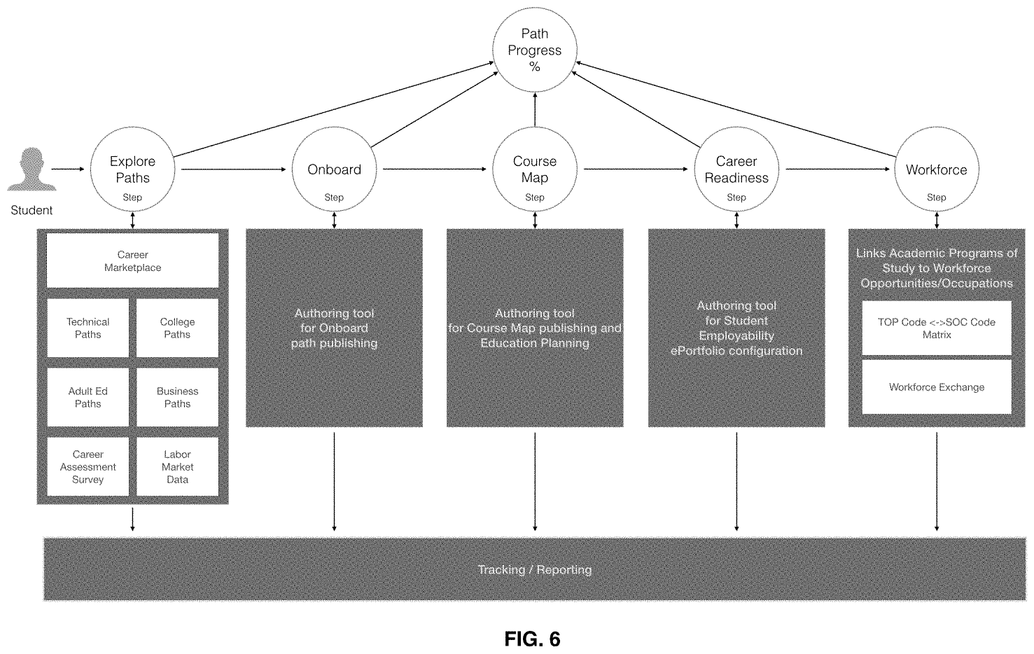

Referring to FIG. 5 and FIG. 6, the Pathways portal of an embodiment of the present invention enables the colleges to create and publish guided career pathways. As depicted in the FIG. 5, there are six key subcomponents of the Pathway system as an embodiment of the present invention. The first subcomponent is the course repository that is populated through a course catalog ingestion using Neuro-Linguistic Programming (NLP) and Machine Learning (ML) algorithms. The next subcomponent is called the path authoring that allows a college to author various guided career pathways. The next subcomponent is career marketplace where the guided career pathways created in the previous component can be published. These pathways can be accessed by both students and adult learners to equip them for selecting and successfully completing the course.

The Pathways component is the core of the system of the present invention. It enables every student to follow a highly structured pathway to intended college success as well career readiness. The Pathway component allows for comprehensive education, industry specific training, and career advancement through a seamless continuum across K-12, postsecondary, workforce, and employer systems. The component gives colleges a powerful and effective tool to publish guided career pathways, designed to engage and equip adult learners who seek skill development, or career changes across a broad, and ever changing, range of careers. The Pathway marketplace also allows colleges to tailor their offerings to target specific industry pipelines, driven by local industry and labor market needs. A subcomponent of the Pathways component in an embodiment of the present invention is Analytics that enables colleges make sense out of the data generated by the guided career pathways for students. The reports generated using the Analytics subcomponent play an important role in tracking student progress and provide system generated alerts and recommendations on any student enrolled in the system. Based on guided career pathway, users profiles are created and matching jobs or internship opportunities are presented to students based on their profiles.

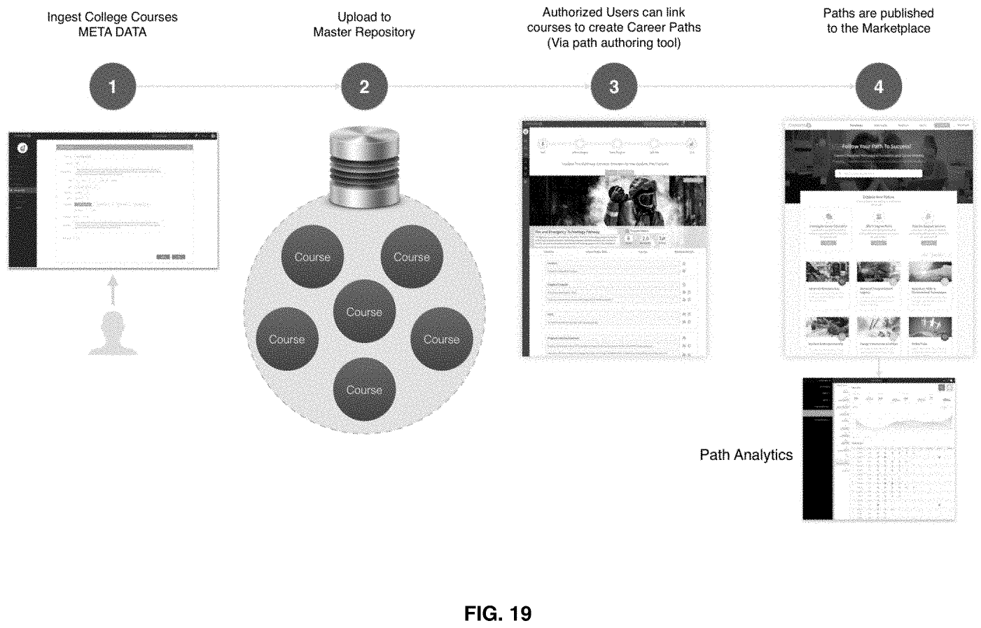

FIG. 19 illustrates the manner in which a user from a college administration interacts with the Pathway component. In the step 1, a user ingests data on college courses. In the step 2, the user uploads the data to the master repository. In the step 3, the user uses a path authoring tool of the system to link different courses to create various career pathways. In the step 4, these paths are published to the path marketplace where the students can access these paths based on the student assessment provided by the system.

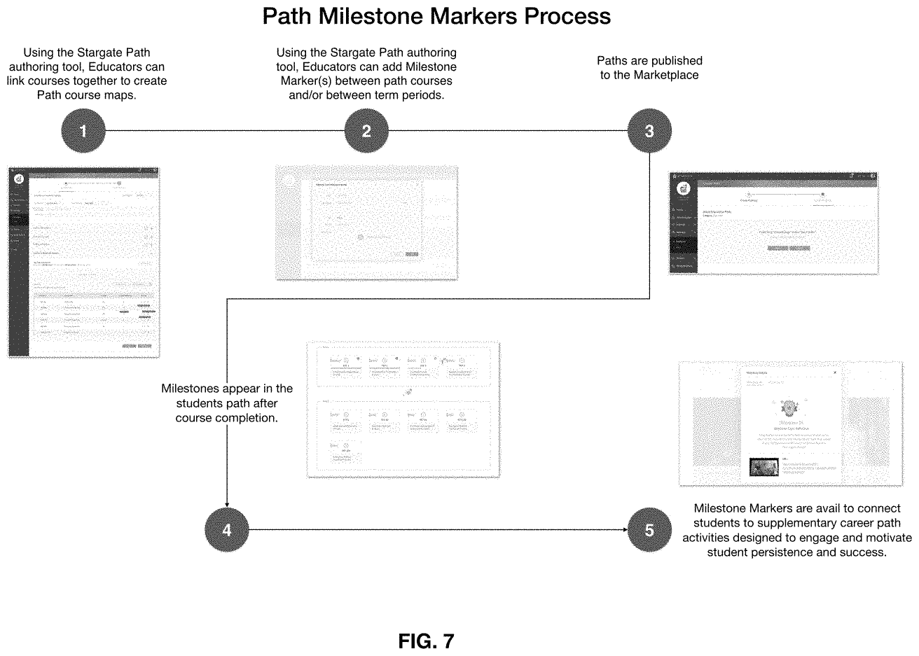

FIG. 7 illustrates how college practitioners can use the path authoring tool to insert Milestone Markers designed to enrich student motivation and participation. Practitioners can insert one of three Milestone Marker types: Progression Milestone Marker (PMM), Activity Milestone Marker (AMM) or Reflective Milestone Marker (RMM). Reflective Milestone Markers help students reflect on their experiences after they have completed a certain module in their pathway course map. Reflective Milestone Markers prompts students to think in a way that applies what has just been learned to future situations. Activity Milestone Markers expose students to career related activities designed to promote milestone success and to help prepare them for the workforce. Career readiness activities that can propel you confidently to the university (this is what strengthens your career concept, validated experiences within a particular career interest area). Progression Milestone Markers have a threshold that is set by a practitioner. This threshold is attached to a student's term, and can be related to grades, test scores, or completed courses. If the student reaches the designated threshold, then a customized congratulatory message will be displayed to the student. If the student fails to reach the threshold, then a customized remediation message will be displayed to the student.

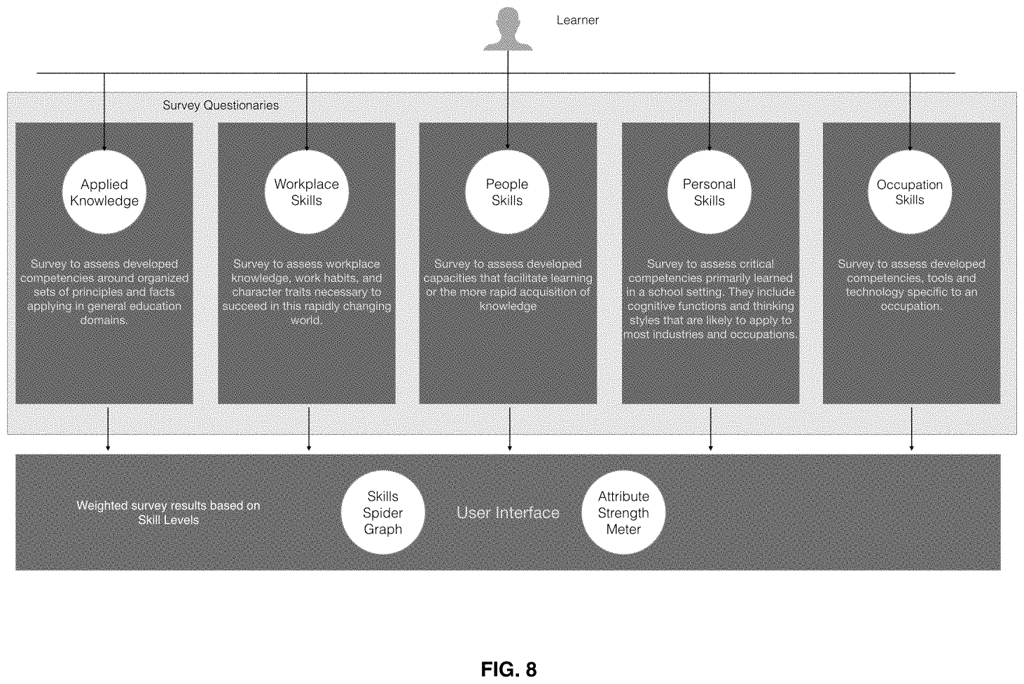

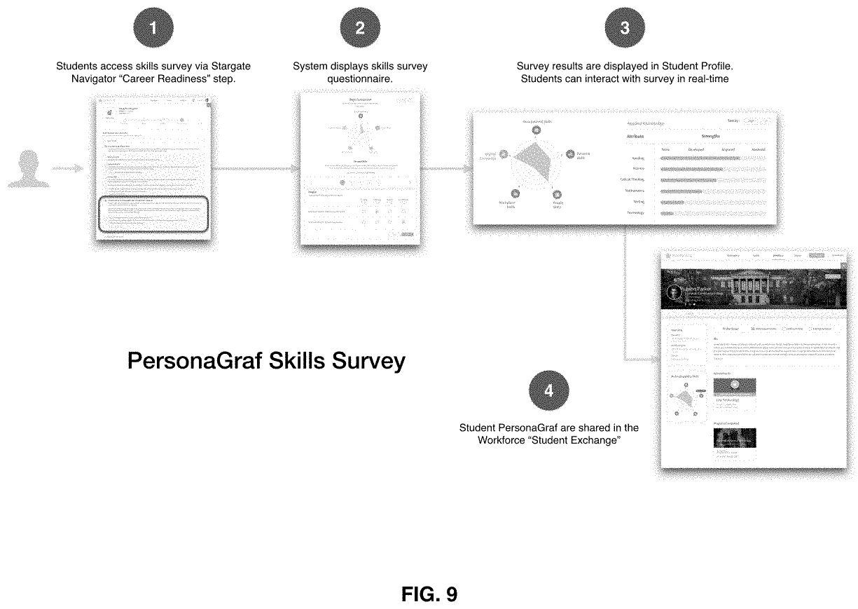

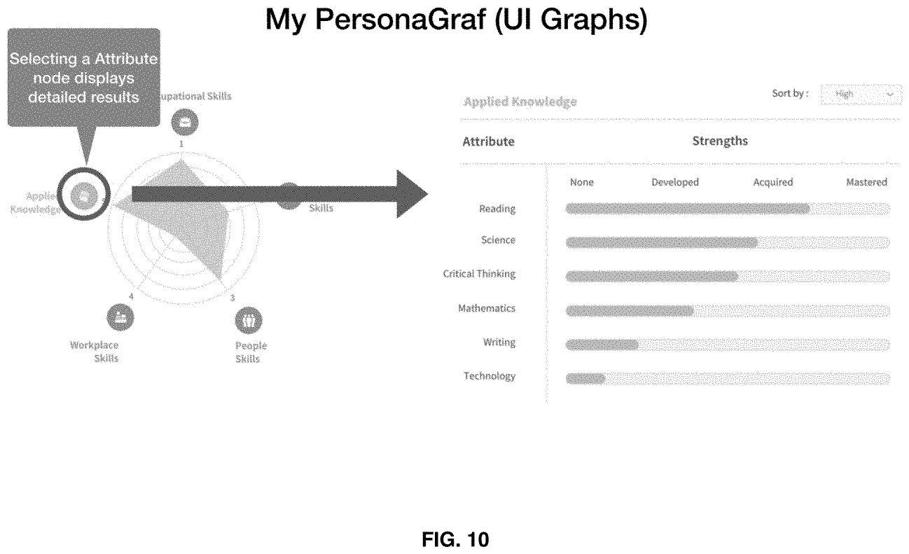

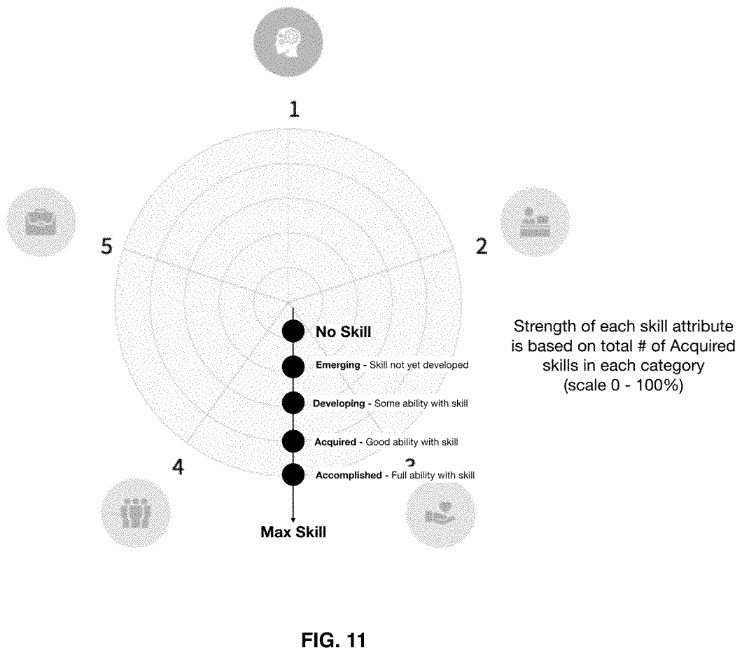

FIG. 8, FIG. 9, FIG. 10 and FIG. 11 illustrate the Personagraf sub-component of the Pathway component. The Personagraf sub-component creates a unique awareness that describes students' employability skills essential for successful workforce performance. The Personagraf is an ongoing catalog listing of a learner's acquired skills across five attributes areas (personal, people, workplace, applied knowledge and occupational). The system catalogs and visually displays all results so that students will know what basic skills employers expect them to have for any job in the workplace, and can better communicate their skill levels to employers. Students will have access to five survey for self assessment and display. Referring to the FIG. 9, through a series of directed survey questionnaires, students can select and provide responses to each survey. Each survey has a number categories and questions related to the selected survey type. Students can select an appropriate “skills rating” for each question. Referring to FIG. 11, “Skills Rating” have an associated weight number. Weights are summed to produce a score for each each survey section. The “strength” of each skill attribute is based on total number of acquired skills in each category The result drives the UI radar chart and the strength indicator widgets. Students can interact and edit surveys for real-time UI chart visualizations. These employability skills are interconnected to allow employers to look at the full scope of what skills are necessary in all major economic sectors. Together, attainment of these business-defined skills prepares individuals for careers and for further education and training.

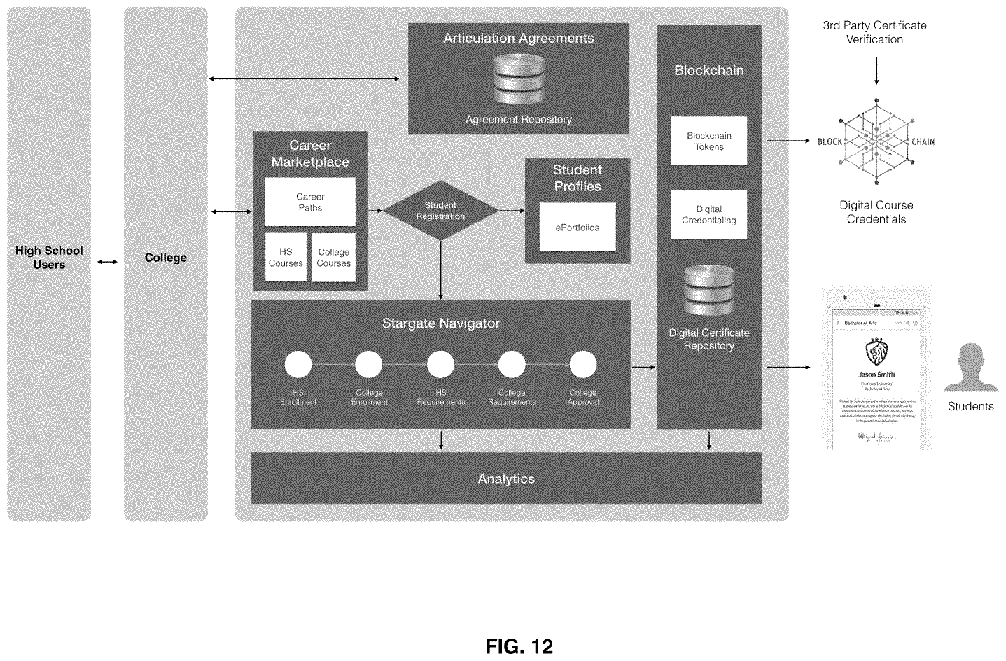

FIG. 12 illustrates the Bridgeway component of an embodiment of the present invention. The bridgeway component affords the K12 learners an opportunity to secure their college credits and view college course completion in relation to their career pathway interest. The Bridgeway component plays an important role in streamlining and automating the enrollment of high school students in college courses, ensures college standards are met for courses in high school, and ensures credits are being accounted for. The component is designed to provide a simple method to enter, update, display and report course articulation outcomes and Career and Technology Education related information for K12 institutions. As illustrated in FIG. 3, the web-based interface of the system allows students, teachers, counselors, and school administrators establish and maintain their own user accounts. Teacher recommendations for credit are available to college counselors and registrars.

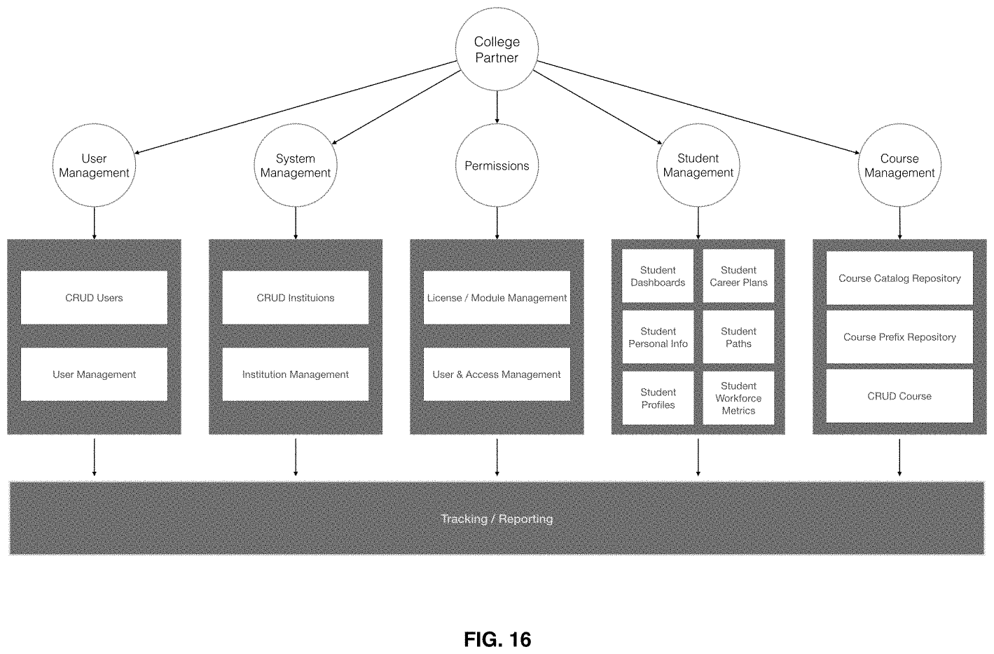

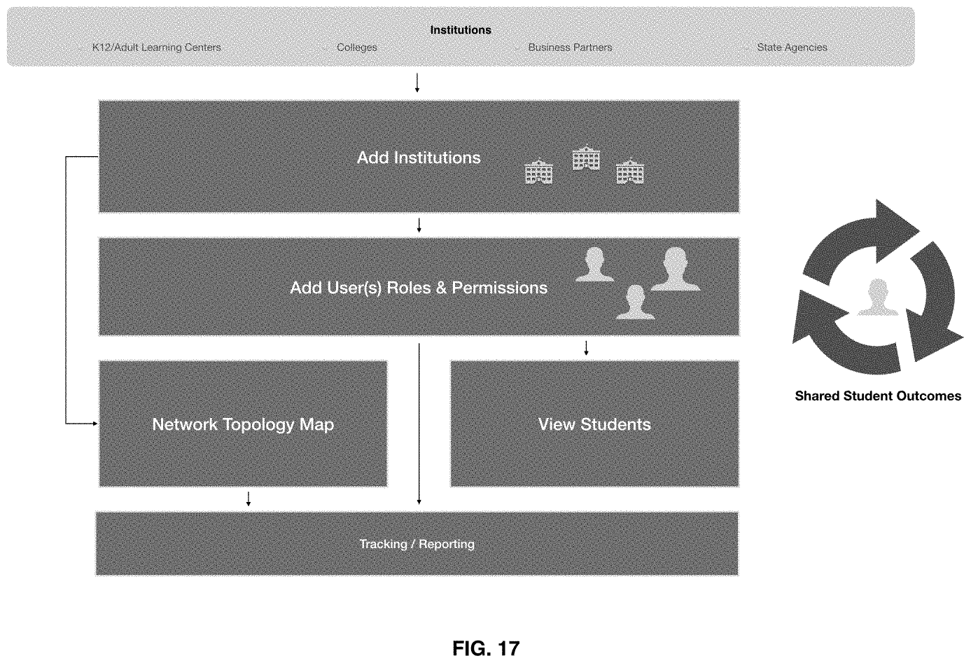

FIG. 16 and FIG. 17 together illustrate the manner in which a user from a college can add an institution and thereby make available to that institution the various reports related to the students progress using the Administration component. Referring to the FIG. 17, in step 1, the user adds one or more institution. For each institution added in the step 1, in the next step, the user can add one or more stakeholders from that institution who would be added to the system as a new user. In the same step, the college user can set roles and permission for each newly created user from that institution. In step 3, these users from the institutions can access and view all the authorized reports from the system.

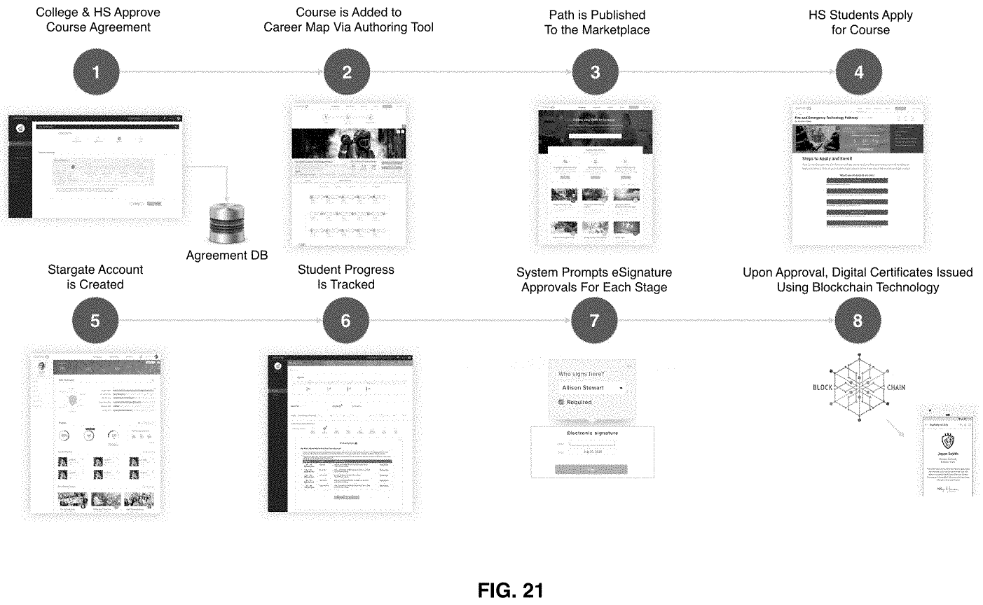

FIG. 21 illustrates the manner in which a user from a college and a user from its feeder high school interacts with the Bridgeway component. In the step 1, a course agreement is drafted and agreed upon and then signed by the college and its feeder high school. This course agreement is a prerequisite for the next steps in the Bridgeway system. The signed agreement is stored by the system in an agreement database. In the step 2, the course as agreed in the signed agreement is added to the marketplace via the pathway authoring tool as illustrated in step 3 of FIG. 21. In step 3, the pathway created from the previous step is published to career marketplace and it becomes available to the students. In step 4, a high school student applies for a course that is available at the marketplace. In step 5, a student account is created on the system and thereby student progress is tracked as depicted in the step 6. As illustrated by the step 7 and step 8 of FIG. 21, at each stage of student progress on a course work, an e-signature approval is prompted by the system. Upon approval by the system, a digital certificate is issued by the system using the blockchain method.

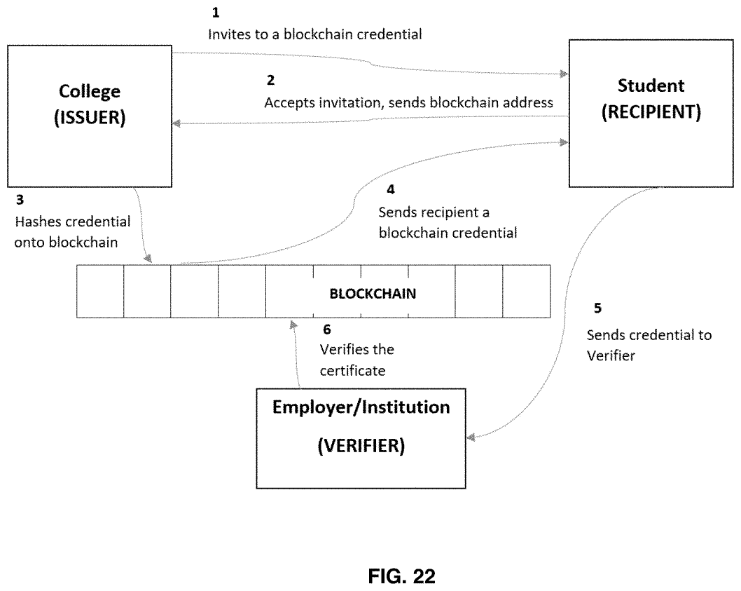

A blockchain component as deployed by the Bridgeway component of an embodiment of the present invention is separately described in the FIG. 22. The blockchain component is used to construct a system that offer colleges an ecosystem for creating, sharing, and verifying blockchain-based educational certificates. As illustrated in the FIG. 22, the blockchain component provides a complete system to issue official credential records using a blockchain-anchored format that is instantly verifiable anywhere in the world. Each student's digital certificates are registered on the Bitcoin blockchain, cryptographically signed, and tamper proof. This component allows college graduates to securely share a verifiable and tamper-proof digital version of their course credits and diplomas with prospective employers and other institutions. Referring to the FIG. 22, in the step 1, the college sends an email to a student and invites to a blockchain credential. In the step 2, if the student accepts the invitation, the student sends back the blockchain address. In step 3, upon receipt of the blockchain address of the student, the college hashes the credential onto blockchain. In step 4, the college sends back the blockchain credential to the student. In step 5, the student shares the credential with an employer or another institution. In the final step, the employer or the institution verifies the credential with the blockchain.

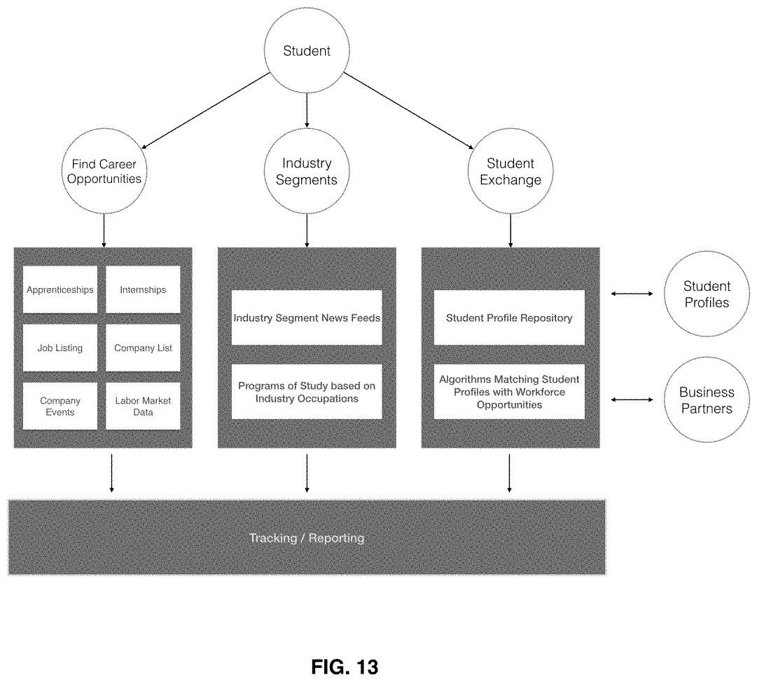

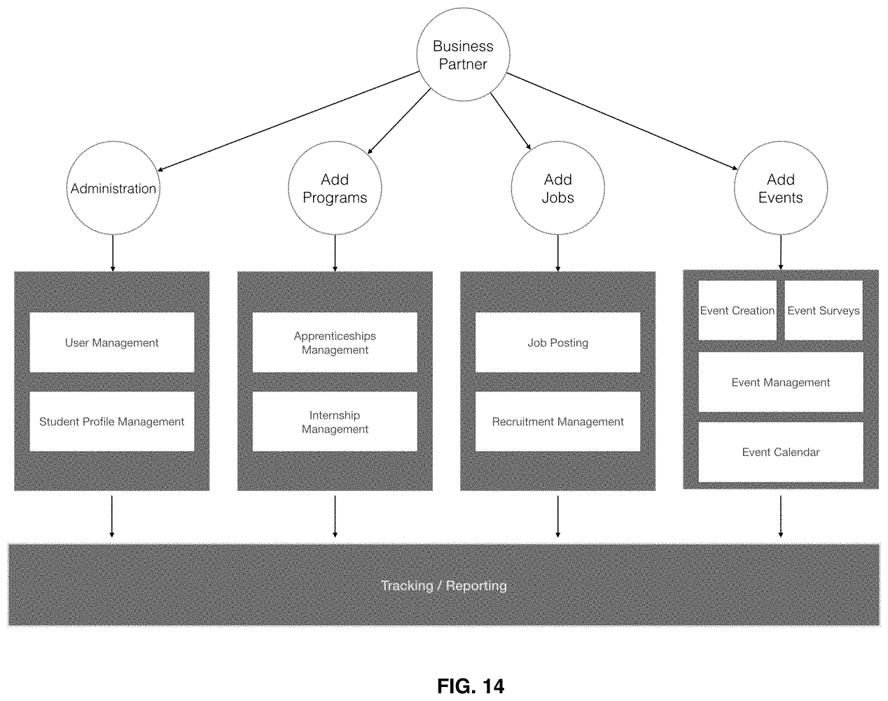

FIG. 13, FIG. 14, and FIG. 15 illustrate the various sub-components of the Workforce component of an embodiment of the present invention. The Workforce component consists of three primary sub-components in the preferred embodiment:

Workforce Portal

FIG. 13 illustrates the Workforce Portal sub-component of the Workforce component of an embodiment of the present invention in which Students log into Stargate's Guided Pathway System (GPS) and are led on a guided experience to determine their skill set, occupational readiness and college on-boarding process. The students choose a career education path that matches their skills and occupational objectives. Once on their education path, students have direct access to the workforce portal allowing them to view jobs and opportunities directly related to their selected career path of choice. The student can post their profile to the Student Exchange giving the Business Partner the ability to see how a student matches up with their job opportunities. Students can also explore and subscribe to industry sectors news feeds that are related to their career interest, as well as explore business partners' profiles, websites, events and various employment opportunities.

Partner Portal

FIG. 14 illustrates the Partner Portal sub-component of the Workforce component of an embodiment of the present invention in which the Business Partners will have an opportunity to share their specific local, regional and national events and job opportunities in the Partner Portal. They align the jobs to career clusters which map directly to the guided pathways the students have selected. This allows the Business Partners to view student profiles that directly relate to the job opportunities posted. The Business Partners see the student profiles that have been posted to the Student Exchange that specializes in helping employers recruit motivated students and graduates for various employment opportunities. The skills matrix and occupational readiness scores give the Business Partners a complete view and matched analysis of students that align with their workforce needs

Strong Workforce Component

FIG. 15 illustrates the Strong Workforce sub-component of the Workforce component of an embodiment of the present invention in which Stargate's Strong Workforce (SWF) Program is a comprehensive design to align regional workforce needs, employers, and labor market data with community colleges in order to train more California learners to succeed in a competitive workforce. The Stargate platform gathers student data from college MIS systems, surveys and direct student and administrative input to provide the metrics for analyzing the success for meeting the Strong Workforce guidelines established by the California Education Department. The Stargate SWF surveys allow the colleges to continuously and seamlessly collect and collate SWF data on students that have succeeded in their program with either a degree or certificate. The data on the students continues to update Stargate and provide analytics for decision making months and years after students have left the program to rejoin the workforce.

The Analytics component of an embodiment of the present invention interacts with and leverages fragmented existing campus technology by centralizing student data and making it easily accessible to all stakeholders. The software program product of the present invention is equipped with a comprehensive data infrastructure that enables the secure and consistent collection and reporting of key performance metrics for all college programs and students. The Analytics component of the product promotes the timely and safe exchange of data for cross-system staff collaboration and system-wide data sharing within and across institutional systems. Using the Analytics component, students are measured through assessment processes and are connected to a number of system-wide metrics and momentum points that will allow stakeholders to track student progression up to and through the workforce. All stakeholders can access a real-time information concerning student service involvement, data, and reports. The program also provides trackable and measurable metrics for program outcomes. Additionally, the program tracks and reports common outcome metrics for all state-funded programs to ensure that they are compatible with federal reporting requirements.

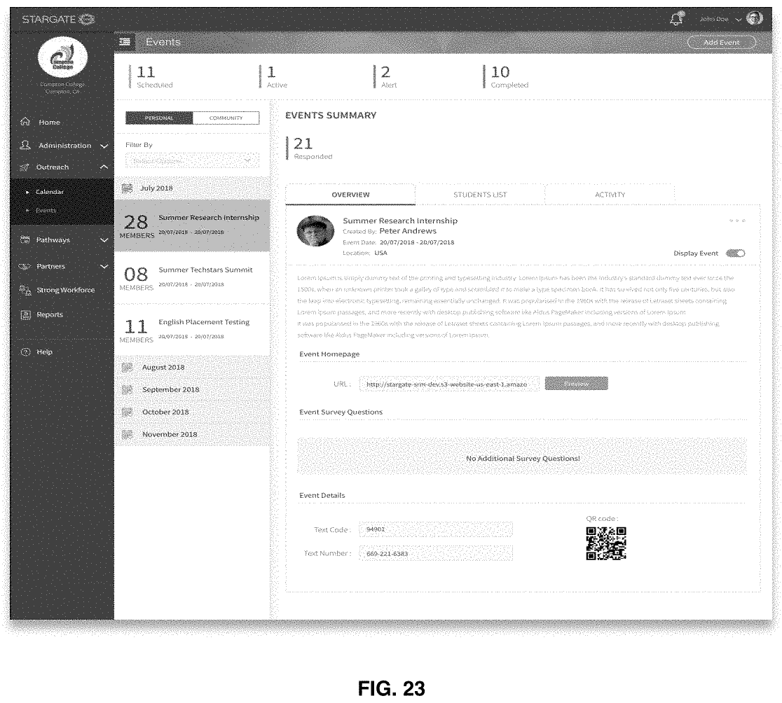

FIG. 23 is a screenshot of generated by a graphical user interface (GUI) of the Outreach component of the computer program. It displays an example of an event that has been created using the computer program.

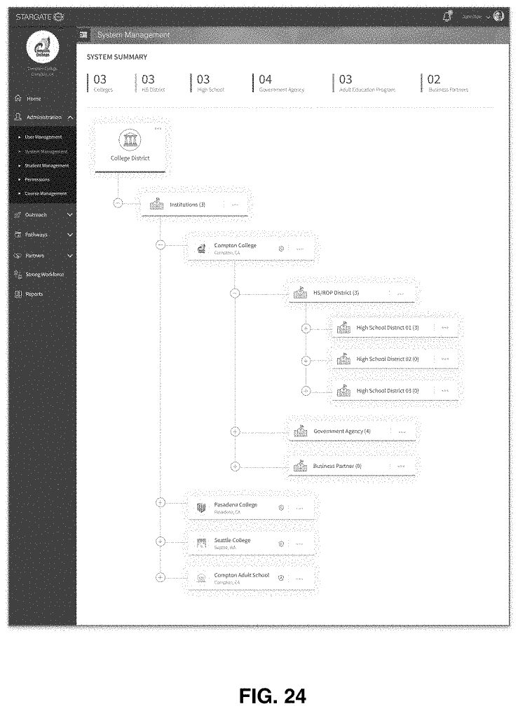

FIG. 24 is a screenshot of generated by a graphical user interface (GUI) of the System Management sub-component of the Administration component. It displays an example of a connected network that has been created using the computer program.

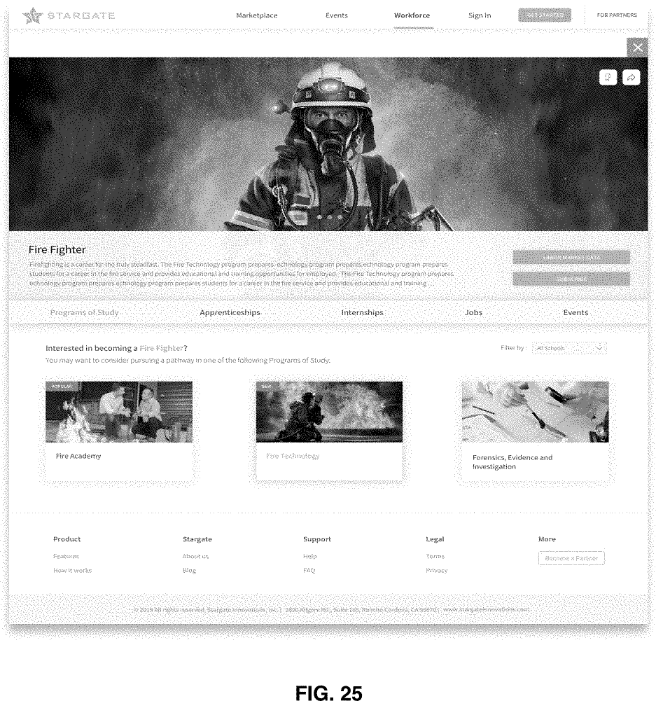

FIG. 25 is a screenshot generated by the graphical user interface (GUI) of the Workforce component of the computer program. It displays an example of a Workforce opportunities that have been created using the computer program.

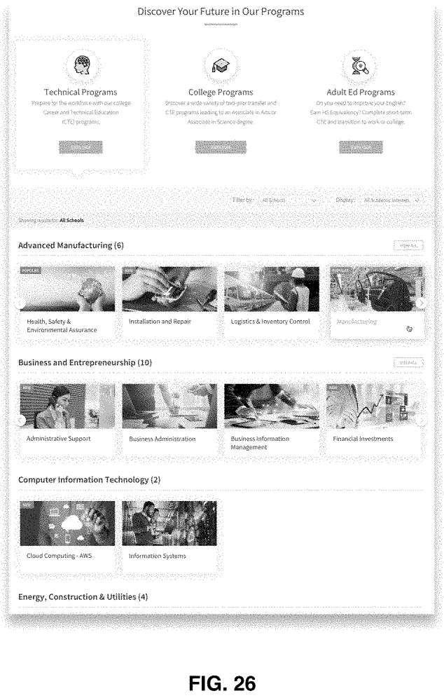

FIG. 26 is a screenshot generated by the graphical user interface (GUI) of the career marketplace sub-component of the Workforce component of the computer program. It displays examples of various career pathways that has been created using the Pathways component of the system.

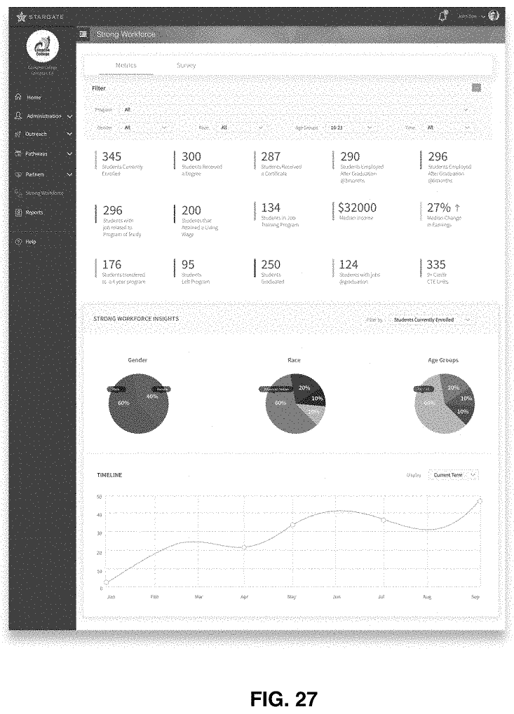

FIG. 27 is a screenshot generated by the graphical user interface (GUI) of the Analytics component of the computer program. It displays an example of the Strong Workforce metrics that are being collected using the computer program.

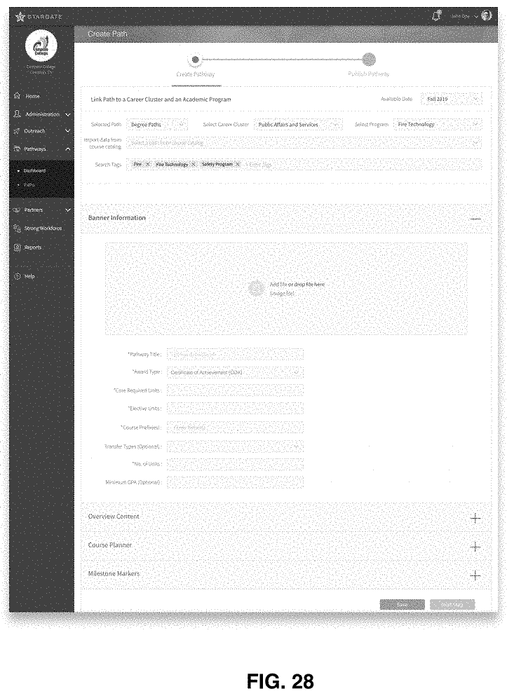

FIG. 28 is a screenshot generated by the graphical user interface (GUI) of the Pathways Authoring component of the computer program. It displays an example of the workflow creation of a guided pathway that is being created using the computer program.

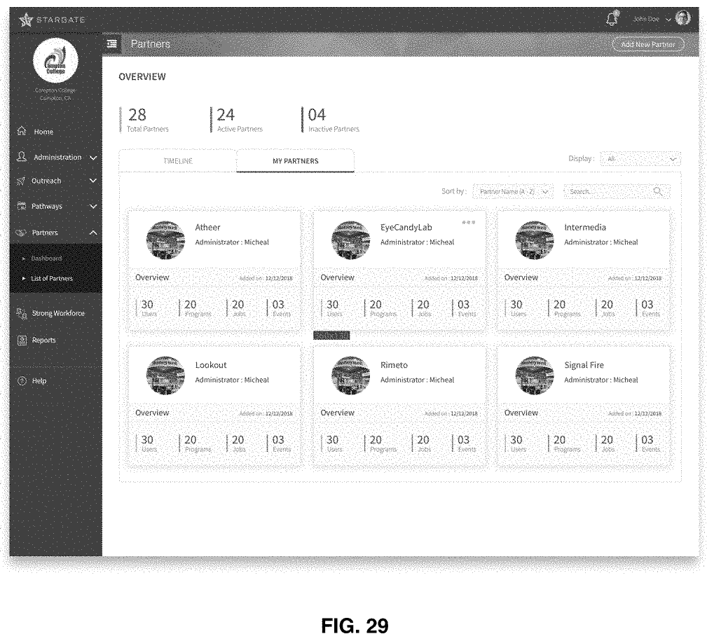

FIG. 29 is a screenshot generated by the graphical user interface (GUI) of the Partners sub-component of the Workforce component of the computer program. It displays an example of the business partners that are being created using the computer program.

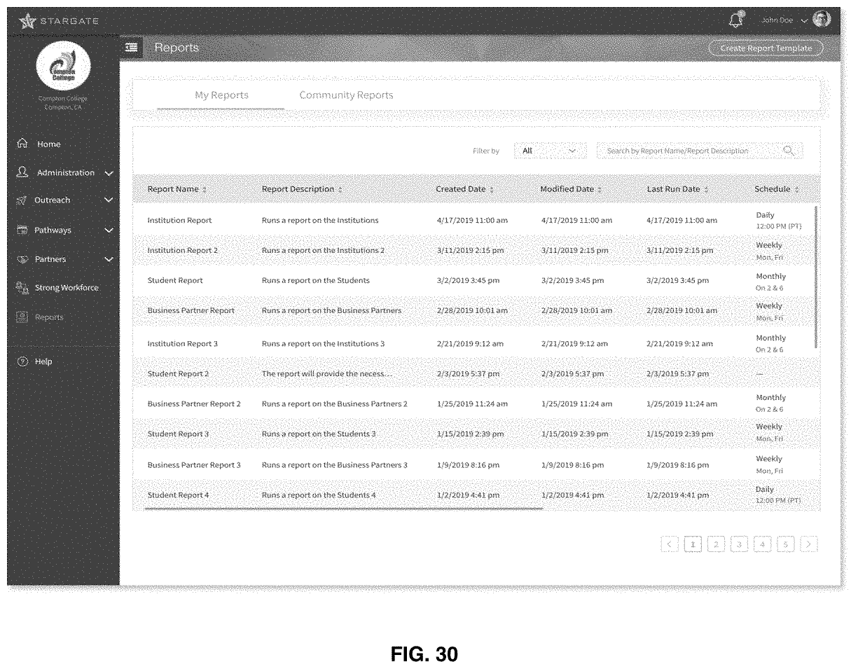

FIG. 30 is a screenshot generated by the graphical user interface (GUI) of the Analytics component of the computer program. It displays another example of the different types of reports that are being created using the computer program.

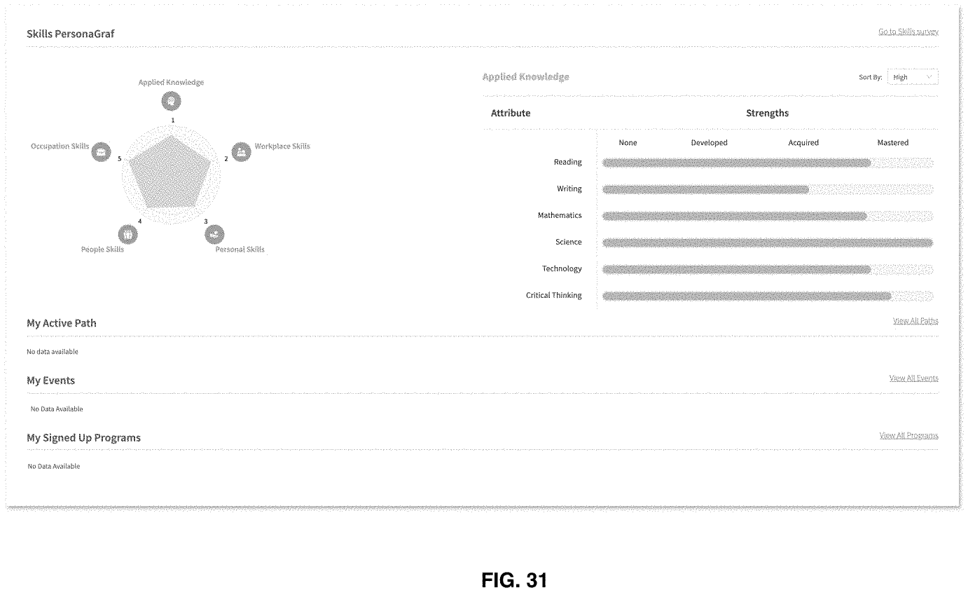

FIG. 31 is a screenshot generated by the graphical user interface (GUI) of the PersonaGraf sub-component of the Pathways component of the computer program. It displays an example of a student's employability skills profile that was created using the PersonaGraf sub-component.

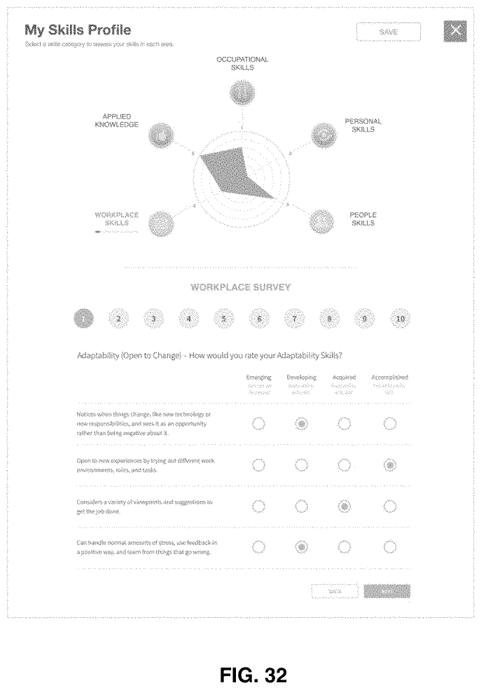

FIG. 32 is another screenshot generated by the graphical user interface (GUI) of the PersonaGraf sub-component of the Pathways component of the computer program. It displays an example of a student's employability skills survey using the PersonaGraf sub-component.

While various embodiments of the present invention have been described above, it should be understood that they have been presented by way of example only, and not limitation. It will be understood by those skilled in the art that various changes in form and details may be made therein without departing from the spirit and scope of the invention. Thus, the breadth and scope of the present invention should not be limited by any of the above-described exemplary embodiments. The invention is defined solely by the appended claims including any amendments made during the pendency of this application and all equivalents of those claims as issued.

What is claimed is:

1. A computer-implemented educational management system for a college to carry out education management of its students, the system comprising: at least one database for storing student information; and a student outreach module configured to engage with students while they are studying at high school and they are assessing and exploring their postsecondary education options available at the college; a career pathway module configured to publish and manage guided career pathway with a purpose to empower current college students with clarity and ease to manage their study plan; a bridgeway module that seamlessly integrate with the feeder K-12 students of the college; a workforce module configured to establish business and enterprise partnerships with a purpose to connect current college students to workforce opportunities; an administrator module that is configured to track the current college student progress and provide the student data to different stakeholders who are authorized to receive the real-time information on the student performance of the college.

2. The system of claim 1, further comprising a skill assessment module configured to empower current college students with a skills building survey tool.

3. The system of claim 1, wherein the pathway module is further configured to offer a pathway authoring tool with a purpose to design career pathway maps linked to educational certificate and degree programs.

4. The system of claim 1, wherein the workforce module is further configured to help students backward map occupational plans by focusing on labor market information critical to regional workforce opportunities and encourage the completion of work-based learning to substantiate career interests.

5. The system of claim 1, wherein the bridgeway module is further configured to create, share and verify blockchain based educational certificates.

6. A computer-implemented educational management method for a college to carry out education management of its students, the method comprising: reaching out to students while these students are studying at high school and are assessing and exploring their postsecondary education options available at the college; publishing and managing guided career pathway to empower current college students with information and ease of creating and managing study plan; integrating feeder K-12 students with the college; establishing business and enterprises partnerships to connect current college students to workforce opportunities; tracking current student progress and providing student data to different stakeholders.

7. The method according to claim 6, wherein further comprising: providing skill assessment to current college students with a skills building survey tool.

8. The method according to claim 6, wherein further comprising: offering a pathway authoring tool to the college staff with a purpose to design career pathway maps linked to educational certificate and degree programs.

9. The method according to claim 6, wherein further comprising: providing labor market information that are critical to regional workforce opportunities.

10. The method according to claim 6, wherein further comprising: creating, sharing and verifying blockchain based educational certificates

11. A computer program product comprising a non-transitory computer-readable medium having computer-readable program instructions stored therein, wherein said computer-readable program instructions comprise: instructions configured to provide student outreach to college staff so that the staff can engage with students of its feeder high schools to help them assess and explore postsecondary education options at the college; provide career pathways that can empower current college students with clarity and ease to create and manage study plan at the college; provide seamless integration with the feeder K-12 students; provide partnerships with businesses and enterprises that connect current college students to workforce opportunities; provide student progress information to all stakeholders in real-time.

12. The computer program product of claim 11, further comprising instructions configured to provide skill assessment to current college students with a skills building survey tool.

13. The computer program product of claim 11, further comprising instructions configured to offer a pathway authoring tool with a purpose to design career pathway maps linked to educational certificate and degree programs.

14. The computer program product of claim 11, further comprising instructions configured to provide labor market information that is critical to regional workforce opportunities.

15. The computer program product of claim 11, further comprising instructions configured to create, share and verify blockchain based educational certificates
